(19) United States
(12) Patent Application Publication
(10) Pub. No.: US 2010/0141446 A1
(43) Pub. Date: Jun. 10, 2010

(54) METHOD AND SYSTEM FOR AUTOMATICALLY TRACKING AND CONTROLLING THE USAGE OF REMOVABLE HARD DRIVES

(75) Inventors: Richard T. Horn, Claremont, CA (US); Lynn Rochelle Kirby-Mello, Pasadena, CA (US)

Correspondence Address: Xerox Corporation (CDFS), 445 Broad Hollow Rd.-Suite 420, Melville, NY, 11747, US

(73) Assignee: XEROX CORPORATION, Norwalk, CT (US)

(21) Appl. No.: 12/330,960

(22) Filed: Dec. 9, 2008

(51) Int. Cl. G08B 13/14

(52) U.S. Cl. 340/572.1

(57) ABSTRACT

A method and a system for automatically tracking and controlling usage of a first set of components, including the steps of receiving data from one or more radio frequency identification (RFID) tags electrically coupled with a second set of components; checking whether the first set of components are permitted to communicate with the second set of components; and enabling the first set of components to transfer data between the first and second set of components when communication is permitted.

### BACKGROUND

The present disclosure relates to removable hard drives and information security, and more particularly, to a method and a system for automatically tracking and controlling the usage of removable hard drives for segregating data and ensuring information security.

Automatic Identification and Data Capture, also known as AIDC, refers to the method of automatically identifying objects, collecting data about such objects, and entering that data directly into computer systems (or other mediums of storage) with minimal, or no, human involvement. AIDC technologies include barcodes, and radio frequency identification (RFID). An AIDC device is a device for reading, and/or writing, data encoded in AIDC media, such as a barcode scanner for reading data encoded in a barcode, or an RFID interrogator for reading and/or writing data encoded in an RFID tag.

RFID is a method for automatic identification which uses radiofrequency (RF) signals. A device known as an RFID interrogator which includes an RFID writer and/or a RFID reader, wirelessly reads, and optionally, writes data stored in a transponder, known as an RFID tag, that is physically attached to an article, such as a product, packaging or shipping container or any type of hardware. Typically, an RFID tag consists of two main components: an integrated circuit (IC) for storing and processing data and for modulating and demodulating the RF signal, and an antenna coupled to the chip that enables the chip to exchange data between the tag and interrogator. An RFID tag can be read-only, wherein the IC contains unalterable data, such as a unique identification code indelibly encoded by the tag manufacturer which is used to uniquely identify the tag. Alternatively, an RFID tag can be read-write, wherein the stored data can be changed or deleted. Typically, however, a read-write RFID tag also contains read-only data, such as an indelible unique identification code, so that individual tags can be uniquely identified.

RFID tags ordinarily range in sizes from several inches to sizes no larger than a grain of rice. RFID tags can be constructed using an essentially planar form factor and incorporated into a self-adhesive label, for example. It is expected the ability to print RFID tags, much like a barcode is printed, will eventually become widespread using, for example, techniques developed by Xerox™ for depositing liquid polythiophene semiconductors onto a surface at room temperature.

RFID tags may be incorporated into or onto a plurality of devices. For instance, removable hard drives (RHDs) could be incorporated with RFID tags. RHDs are employed in many computing systems. In many instances, several individuals may have access to a secure storage area where RHDs are utilized. The disadvantages of such a system are many. One disadvantage is that it is very cumbersome to track a list of individuals who use RHDs to store or obtain information on secure storage areas. Another disadvantage is that full scale accounting of monitored items is extremely slow. Additionally, it is even more onerous to account for the duration of time that individuals had access to these secure storage areas. The combination of slow accounting of information and high speed copying and transmission of computer information allows individuals to copy or steal the information from the secure storage areas with the aid of the RHDs.

Currently, the trend in storage technology is towards greater capacities, smaller sizes, and faster speeds of transfer of information. Small, portable storage devices that include several megabytes of information capacity pose a serious threat to information security. In addition, RHDs allow users to transfer information from one computer to another in the same entity and/or from one computer to another located in a different entity. An entity desires to prevent unauthorized information from being inadvertently, deliberately, or maliciously transferred into their computing systems. Most users of RHDs currently use different schemes of applying labels to drives, computers, and carriers to help reduce the likelihood of “cross contamination” from loading the wrong disks at the wrong time. However, this approach is not effective in preventing “mishaps” in information security from occurring.

Consequently, a manual system would not accurately inventory nor track RHDs accessing computing systems, and would not effectively track the accountability of individuals accessing secure storage areas. The present disclosure is intended to overcome the drawbacks of other methods by providing for automatic tracking and controlling of the usage of RHDs. In particular, the present disclosure relates to a system and method for automatically tracking and controlling the usage of RHDs by providing for built-in check points via the utilization of RFID tags.

### SUMMARY

The present disclosure provides a system for automatically tracking and controlling usage of a first set of components, including one or more radio frequency identification (RFID) tags electrically coupled with a second set of components; wherein the RFID tags enable the first set of components to transfer data between the first and second set of components.

The present disclosure also provides a method for automatically tracking and controlling usage of a first set of components, including the steps of receiving data from one or more radio frequency identification (RFID) tags electrically coupled with a second set of components; checking whether the first set of components are permitted to communicate with the second set of components; and enabling the first set of components to transfer data between the first and second set of components when communication is permitted.

### BRIEF DESCRIPTION OF THE DRAWINGS

Various embodiments of the present disclosure will be described herein below with reference to the figures wherein:

FIG. 1 is a schematic diagram of a conventional RFID tag;

FIG. 2 is a schematic diagram of a conventional RFID tag in communication with an RFID reader;

FIG. 3 is a block diagram depicting a system for automatically tracking and controlling usage of one or more removable storage devices connected to a network, in accordance with the present disclosure;

FIG. 4 is a block diagram depicting a system for automatically tracking and controlling usage of one or more removable storage devices not connected to any network, in accordance with the present disclosure; and

FIG. 5 is a flow chart diagram illustrating a method for automatically tracking and controlling usage of one or more removable storage devices connected to a network, in accordance with the present disclosure.

### DETAILED DESCRIPTION

Removable hard drives (RHDs) are used by individuals to segregate operating software and data systems for security and confidentiality of information purposes. In conventional systems, multiple sets of RHDs are used on the same computers with various types of stick-on labels to identify content and use of the RHDs. However, without effective processes for tracking and handling the RHDs, the RHDs can be loaded at the wrong time and many times corrupt the system from further use.

The present disclosure illustrates a system and method for automatically tracking and controlling usage of one or more RHDs connected or nor connected to any network. Thus, the present disclosure is capable of operating in two primary modes. The first mode requires (i) the addition of new software on each computer within the system, (ii) embedded hardware that contains an RFID tag for each drive of each computer, and (iii) a network connection to a central computer system with new interactive software. The second mode is desirable where for security reasons a network connection would not be allowed to a central computer system.

The present disclosure supports the initialization of both operating computer and disk drives to function when their respective RFIDs match a list of permissible systems set during system initialization. In addition, for multiple drive systems, the drives function if placed in their respectively correct external drive receiving slots. All electronic activities including, but not limited to, loading time, unloading time, data loaded, failure to load, time of access, etc. are recorded in a log maintained on the drive and transmitted to a central network computer, if such a connection is available and permitted.

As a result, it is desirable for many individuals who utilize RHDs in their computer systems, whether it is for general desktop use or for printer controller use, that those drives be controlled so that only the intended operating software and data systems are used at any particular time. For example, disks that contain an entity's operating financial information and/or proprietary software could be inadvertently loaded into a computer that is network connected to a completely different entity for purposes of data transfer. Furthermore, a print fulfillment business may have customers with different mailing address lists on those disks that cannot allow, “Commingling” with other customers' lists that might be competitors.

As a result, the present disclosure proposes built-in checks through the use of embedded RFID tags in order to ensure that the correct drives are loaded in the correct locations. Through the firmware and software provided, operational tracking information can be effectively collected and additional control over what passes through the computer system at a particular time can be properly implemented.

The present disclosure further proposes the use of RFID tags on the disk drive sets and a receiver on the computer systems. Typically, during initial setup of a disk drive set, one of the drives is loaded with the intended operation software. In the meantime, the computer system and the other drives are configured as additional data storage or spooling areas. The present disclosure, by the use of an RFID receiver in communication with the computer system, records the RFID tags of all the new drives during setup and stores them in local non-volatile memory as permissible drives. From that point on, the software prevents the computer from operating unless all the drives of a particular set are loaded in their respective slots. Not only does the system not allow operation to take place but the firmware records each attempt to load incorrect disks or disks in the wrong slots and provides error light indicators related to the problematic condition.

Moreover, the present disclosure proposes, in addition to the firmware logging in failed attempts, for the firmware to write operational data to the operating system logs on the main drive. If this computer is networked to a central computer system, the log information can then be uploaded on demand for operations tracking and control. The information uploaded would include the respective disk set RFIDs and further control over the data being passed through the central system to this computer for processing.

Embodiments will be described below while referencing the accompanying figures. The accompanying figures are merely examples and are not intended to limit the scope of the present disclosure.

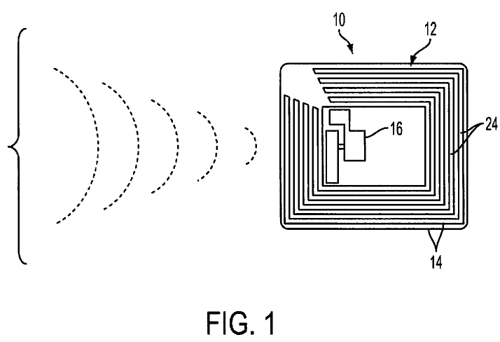

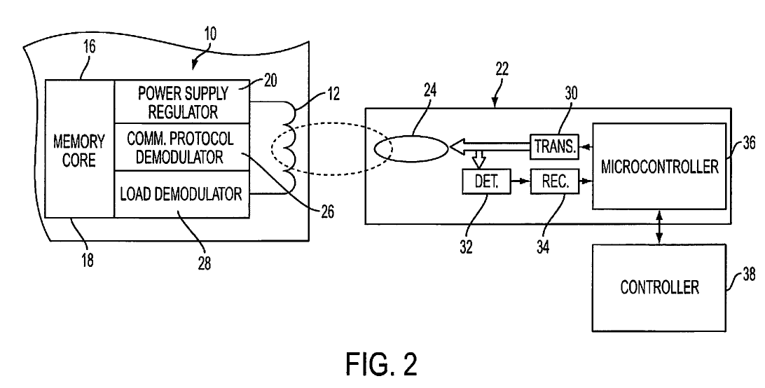

Referring to FIGS. 1 and 2, there is shown a conventional RFID tag 10 for use in a system for automatically tracking and controlling the usage of RHDs to ensure information security. The tag 10 includes a tag antenna 12 composed of a plurality of antenna elements 14 which, for example, may be wound in a substantially rectangular pattern and connected to an integrated circuit chip 16, also known as a RFID chip. Within the tag 10, data storage and processing, as well as RF communication functions, are performed by the RF identification chip 16.

As shown in FIG. 2, the chip 16 is a passive type and may include, for example, a memory core 18 (e.g., an EEPROM or flash memory), which stores the data, a power supply regulator 20, which rectifies and otherwise conditions alternating current induced in the antenna 12 by a time-varying RF signal provided by a reader or coupler 22 and its antenna 24 for use in the tag 10 as a direct current power source, and receiver/emitter modules 26, 28 (e.g., compatible with the ISO 14443 standard).

The reader 22 includes a transmitter 30 that generates the time-varying RF signal transmitted by the antenna 24. As a result of electromagnetic coupling between the tag antenna 12 and the reader antenna 24, a portion of the RF signal transmitted by the tag antenna 12 enters the reader antenna 24 and is separated from the transmitted signal by a detector 32 (e.g., an envelope detector). The separated signal is passed to a receiver 34, where it is amplified, decoded and presented via a microcontroller 36 to a controller 38, which may be a host computer, for example.

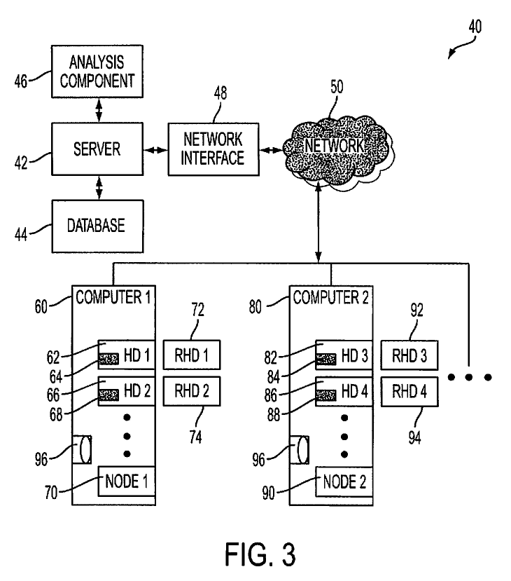

With reference to FIG. 3, a block diagram depicting a system for automatically tracking and controlling usage of one or more removable storage devices connected to a network, in accordance with the present disclosure is presented. The system 40 includes a server 42, a database 44, an analysis component 46, a network interface 48, and a network 50. The network 50 is connected to a first computer 60 and to a second computer 80. However, the network 50 may be connected to a plurality of computers. Computer 60 includes a first hard drive input port 62 having a first RFID tag 64, a second hard drive input port 66 having a second RFID tag 68, a node 70, and RFID compatible software 96. Computer 60 may also be in operable communication with a first removable hard drive 72 and a second removable hard drive 74. Computer 80 includes a third hard drive input port 82 having a third RFID tag 84, a fourth hard drive input port 86 having a fourth RFID tag 88, a node 90, and RFID compatible software 96. Computer 80 may also be in operable communication with a third removable hard drive 92 and a fourth removable hard drive 94.

The term “component” can be defined herein as a constituent element of a system. The term “component” can also refer to an identifiable part of a larger program, system or construction. A system, as described with respect to the present disclosure, may be divided into several components. A component can be one element of a larger system. Usually, a component provides a particular function or group of related functions for such larger system. The term “component” can also refer to a building block that can be combined with other components in the same or other systems/computers in a distributed network to perform a desired application. Components can be deployed on different servers in a network having a plurality of computers to enable communication between the servers and the computers for needed services. The term “component” may refer to elements in a system that are electrically coupled with each other or are capable of electrical communication with each other. A “component” may also be an electrical subsystem, which subsystem is a set of elements. A “component” may also refer to hardware components, software components, services, and/or resources.

The database 44 may be implemented using a variety of devices for storing electronic information. It is understood that the database 44 may be implemented using memory contained in the network interface 48, user systems (e.g., computers 60, 80), or it may be a separate physical device. The database 44 is logically addressable as a consolidated data source across a distributed environment that includes a network 50. Information stored in the database 44 may be retrieved and manipulated via the network interface 48 and/or via one or more user systems 60, 80.

The analysis component 46 is in communication with the server 42 and the network 50. Network interface 48 interfaces with network 50, thus facilitating analysis component 46 to be in operative communication with the network 50. Analysis component 46 is in operative communication with nodes 70 and 90 by utilizing network interface 48 and network 50. Analysis component 46 may also be configured to compare a predetermined list of permissible RHDs (e.g., 72, 72, 92, 94) to be connected to the hard drive input ports (e.g., 62, 66, 82, 86). Additionally, analysis component 46 may keep track of any and all electronic activities occurring when one or more RHDs (e.g., 72, 74, 92, 94) make an attempt to connect to any of the hard drive input ports (e.g., 62, 66, 82, 86).

The network interface 48 may be implemented using one or more servers operating in response to a computer program stored in a storage medium accessible by the server 42. The network interface 48 may operate as a network server (e.g., a web server) to communicate with the user systems (e.g., computers 60, 80). The network interface 48 may handle sending and receiving information to and from the user system (e.g., 60, 80) and may perform associated tasks. The network interface 48 may also include a firewall to prevent unauthorized access to the network interface 48 and enforce any limitations on authorized access. A firewall may be implemented using conventional hardware and/or software in a manner those skilled in the art would appreciate. The network interface 48 may also operate as an application server. The network interface 48 may also execute one or more computer programs to perform the processing described herein. Processing may be shared by the user systems (e.g., 60, 80) and the network interface 48 by providing an application to the user systems (e.g., 60, 80).

The network 50 may be any type of known network including, but not limited to, a wide area network (WAN), a local area network (LAN), a global network (e.g. Internet, cellular), a virtual private network (VPN), and an intranet. The network 50 may be implemented using a wireless network or any kind of physical network implementation. Any type of user system (e.g., computers 60, 80) may be coupled to a host system (e.g., a network interface 48) through multiple networks (e.g., intranet and Internet) so that not all user systems are coupled to the host system (e.g., network interface 48) through the same network. One or more of the user systems (e.g., 60, 80) and the network interface 48 may be connected to the network 50 in a wireless fashion.

Computers 60, 80 may include a plurality of hard drive input ports (e.g., 62, 66, 82, 86), each having an RFID tag (e.g., 64, 68, 84, 88). The amount of computers, hard drive input ports, and RFID tags are not limited in number. Each computer (e.g., 60, 80) may include a node (e.g., 70, 90) that is in operable communication with the network 50 in order to send information related to the hard drive input ports (e.g., 62, 66, 82, 86) and the RFID tag (e.g., 64, 68, 84, 88) to the server 42, the database 44, and/or the analysis component 46 for further processing.

Therefore, in the first mode, the addition of: (i) new software (e.g., 96) on each computer (e.g., 60, 80) within the system (e.g., 40), (ii) embedded hardware (e.g., 62, 66, 82, 86) that contains an RFID tag (e.g., 64, 68, 84, 88) for each drive of each computer (60, 80), and (iii) a network connection (e.g., 50) to a central computer system (e.g., 42, 46), aids in providing for automatic tracking and controlling of usage of one or more RHDs for effectively securing information.

In addition, the one or more RHDs (e.g., 72, 74, 92, 94) may be considered as a first set of devices/components and the computers (e.g., 60, 80) may be considered as a second set of devices/components in operable communication with each other. The RFID tags (e.g., 64, 68, 84, 88) may directly communicate with the second set of components (e.g., 60, 80) and the analysis component 46 can be used to determine at least whether the first set of components are permitted to communicate with the second set of components.

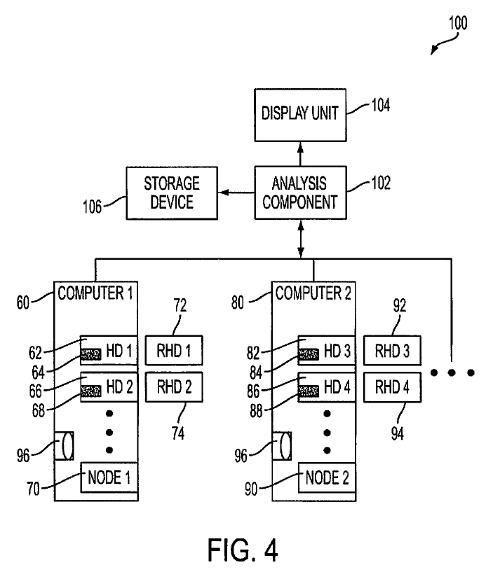

With reference to FIG. 4, a block diagram depicting a system for automatically tracking and controlling usage of one or more removable storage devices not connected to any network, in accordance with the present disclosure is presented. The system 100 includes an analysis component 102, a display unit 104, and a storage device 106. The analysis component 102 is further connected to one or more computers (e.g., 60, 80). For illustrative purposes, the analysis component 102 is connected to 2 computers, a first computer 60 and a second computer 80. However, analysis component 102 may be connected to a plurality of computers.

Computer 60 includes a first hard drive input port 62 having a first RFID tag 64, a second hard drive input port 66 having a second RFID tag 68, a node 70, and RFID compatible software 96. Computer 60 may also be in operable communication with a first removable hard drive 72 and a second removable hard drive 74. Computer 80 includes a third third hard drive input port 82 having a third RFID tag 84, a fourth hard drive input port 86 having a fourth RFID tag 88, a node 90, and RFID compatible software 96. Computer 80 may also be in operable communication with a third removable hard drive 92 and a fourth removable hard drive 94.

Analysis component 102 is in direct communication with computers 60, 80. Analysis component 102 is in operative communication with nodes 70 and 90 without utilizing a network interface and/or a network connection. Analysis component 102 may also be configured to compare a predetermined list of permissible RHDs (e.g., 72, 72, 92, 94) to be connected to the hard drive input ports (e.g., 62, 66, 82, 86). Additionally, analysis component 102 may keep track of any and all electronic activities occurring when one or more RHDs (e.g., 72, 74, 92, 94) make an attempt to connect to any of the hard drive input ports (e.g., 62, 66, 82, 86).

Display unit 104 can be any type of display device contemplated by one skilled in the art. For example, display devices used for monitors of computers and television sets generally include self-emitting display devices such as organic light emitting displays (OLEDs), vacuum fluorescent displays (VFDs), field emission displays (FEDs), and plasma display panels (PDPs), and non-emitting display devices such as liquid crystal display devices (LCDs) requiring external light source.

Storage device 106 is in operable communication with analysis component 102 and with display unit 104. Information stored in the storage device 106 may be retrieved and manipulated via the one or more computers 60, 80.

In contrast to FIG. 3, in FIG. 4 there is no network connection or network interface. Therefore, the second mode is desirable for situations where, for security reasons, a network connection would not be allowed to a central computer system. Thus, in the second mode, built-in checks through the use of embedded RFID tags (e.g., 64, 68, 84, 88) are used in order to ensure that the correct RHDs (e.g., 72, 74, 92, 94) are loaded in the correct locations. Through the firmware and software provided, even without a network connection, operational tracking information can be effectively collected and additional control over what passes through the system at a particular time can be effectively implemented.

In addition, a further expansion of the present disclosure would be to embed an RFID tag in the computer itself and then provide a hand held RFID reader, which is also loaded during initial setup, with the desired information. This RFID reader would be used to ensure that the correct drives are retrieved from storage device for a particular computer by indicating, for example, with lighting means or visual means or audible means, if a particular drive matches and in what external drive bay it belongs to.

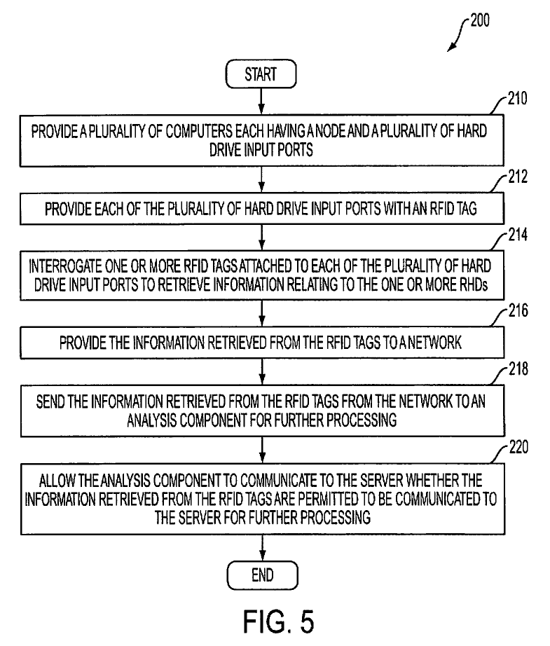

With reference to FIG. 5, a flow chart diagram illustrating a method for automatically tracking and controlling usage of one or more removable storage devices connected to a network, in accordance with the present disclosure is presented. The flow diagram 200 includes the following steps. In step 210, a plurality of computers each having a node and a plurality of hard drive input ports is provided. In step 212, each of the plurality of hard drive input ports is provided with an RFID tag. In step 214, the one or more RFID tags are provided to each of the plurality of hard drive input ports is interrogated in order to retrieve information relating to the one or more RHDs. In step 216, the information retrieved from the one or more RFID tags is provided to a network. In step 218, the information retrieved from the RFID tags from the network are sent to the analysis component for further processing. In step 220, the analysis component is permitted to communicate to the server whether the information retrieved from the RFID tags are permitted to be communicated to the server. the server. This flow chart relates to the first mode of operation. The second mode of operation can be accomplished by removing reference to a “network” from the flow chart.

In an alternative embodiment of the present disclosure, an RFID tag may be included on an operator of a storage device. The RFID tag included on the operator further limits one or more hard drives to certain computers and certain operators. In other words, a first operator may have access only to one machine within the system. A second operator may have access to several machines within the system, but not all machines. A third operator may have access to all the machines within the system. As a result, an operator-specific RFID tag may effectively limit access of certain individuals having limited authority to access one or more storage devices within the system.

Accordingly, the present disclosure allows for automatically tracking and controlling the usage of RHDs, thus minimizing or even eliminating the risk of data being stolen or mistakenly placed in non-desirable storage device location.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for automatically tracking and controlling usage of a first set of components, the system comprising:
one or more radio frequency identification (RFID) tags electrically coupled with a second set of components;
wherein the RFID tags enable the first set of components to transfer data between the first and second set of components.

2. The system according to claim 1, wherein the first set of components are removable storage elements, the second set of components are fixed storage elements, and the first and second set of components are in operable communication with a server in a network configuration.

3. The system according to claim 1, wherein each of the second set of components includes software capable of communicating with the one or more RFID tags.

4. The system according to claim 1, wherein each of the second set of components is electrically coupled with a node configured to be in operable communication with the one or more RFID tags.

5. The system according to claim 4, wherein the node of each of the second set of components sends RFID tag information to an analysis element.

6. The system according to claim 1, wherein a list of permissible components of the first set of components is provided to an analysis element during setup of the system.

7. The system according to claim 6, wherein initialization of communication between the first and second set of components is permitted when it is confirmed by the analysis element that the first set of components is on the list of permissible components of the first set of components.

8. The system according to claim 1, wherein the first set of components are in operable communication with selective components of the second set of components.

9. The system according to claim 1, wherein electronic activities resulting from the insertion of the first set of components into the second set of components is recorded in a database and transmitted to an analysis element.

10. The system according to claim 9, wherein the electronic activities include at least one of the following: loading time, unloading time, data loaded, data removed, failure to load, and time of access.

11. A method for automatically tracking and controlling usage of a first set of components, the method comprising the steps of:
receiving data from one or more radio frequency identification (RFID) tags electrically coupled with a second set of components;
checking whether the first set of components are permitted to communicate with the second set of components; and
enabling the first set of components to transfer data between the first and second set of components when communication is permitted.

12. The method according to claim 11, wherein the first set of components are removable storage elements, the second set of components are fixed storage elements, and the first and second set of components are in operable communication with a server in a network configuration.

13. The method according to claim 11, wherein each of the second set of components includes software capable of communicating with the one or more RFID tags.

14. The method according to claim 11, wherein each of the second set of components is electrically coupled with a node configured to be in operable communication with the one or more RFID tags.

15. The method according to claim 14, wherein the node of each of the second set of components sends RFID tag information to an analysis element.

16. The method according to claim 11, wherein a list of permissible components of the first set of components is provided to an analysis element during setup of the system.

17. The method according to claim 16, wherein initialization of communication between the first and second set of components is permitted when it is confirmed by the analysis element that the first set of components is on the list of permissible components of the first set of components.

18. The method according to claim 11, wherein the first set of components are in operable communication with selective components of the second set of components.

19. The method according to claim 11, wherein electronic activities resulting from the insertion of the first set of components into the second set of components is recorded in a database and transmitted to an analysis element.

20. The method according to claim 19, wherein the electronic activities include at least one of the following: loading time, unloading time, data loaded, data removed, failure to load, and time of access.

21. A method for controlling a plurality of removable memory devices, the method comprising the steps of:
electrically coupling a plurality of radio frequency identification (RFID) tags to each of a plurality of fixed memory devices;
receiving data from the plurality of RFID tags;
analyzing the data received from the plurality of RFID tags; and
enabling communication between the plurality of fixed memory devices and the plurality of removable memory devices based on the analyzed data.

22. The method according to claim 21, wherein the plurality of removable memory devices are flash memory devices.

23. The method according to claim 21, wherein the plurality of fixed memory devices include software for communicating with the plurality of RFID tags.

24. The method according to claim 21, wherein the plurality of fixed memory devices are located in a server connected to a network.

25. The method according to claim 24, wherein the server includes a network interface in operative communication with the network in order to collect the data from the plurality of RFID tags.

26. The method according to claim 24, wherein the server includes a database interface in operative communication with the network in order to store the data from the plurality of RFID tags processed by an analysis device.

27. The method according to claim 21, wherein a list of permissible removable memory devices is provided to an analysis device during setup of a server.

28. The method according to claim 27, wherein initialization of communication between the plurality of removable memory devices and the plurality of fixed memory devices is permitted when it is confirmed by the analysis device that the plurality of removable memory devices is on the list of permissible removable memory devices.

29. The method according to claim 21, wherein the plurality of removable memory devices are in operable communication with selective fixed memory devices.

30. The method according to claim 21, wherein all electronic activities resulting from the insertion of the plurality of removable memory devices into the plurality of fixed memory devices is recorded in a database interface and transmitted to an analysis device.
